(19) United States
(12) Patent Application Publication
(10) Pub. No.: US 2011/0185282 A1
(43) Pub. Date: Jul. 28, 2011

(54) User-Interface-Integrated Asynchronous Validation for Objects

(75) Inventors: Hamid Mahmood, Seattle, WA (US); Michael John Hillberg, Beaux Arts Village, WA (US); Terry Adams, North Bend, WA (US); Régis Brid, Woodinville, WA (US); Sage Alexander LaTorra, Redmond, WA (US); Nikhil Kothari, Sammamish, WA (US)

(73) Assignee: MICROSOFT CORPORATION, Redmond, WA (US)

(21) Appl. No.: 12/695,212

(22) Filed: Jan. 28, 2010

(51) Int. Cl. G06F 3/00

(52) U.S. Cl. 715/744; 714/57

(57) ABSTRACT

An asynchronous data validation mechanism integrated into a user interface by a binding engine is provided. Application object properties are bound to user interface data fields. The asynchronous validation mechanism communicates with a validator and with the object properties. Data input to a single field can be flagged with multiple validation errors. Multiple validation errors can also be associated to the object overall rather than being associated with particular properties of the object. Inconsistency between inputs to different data fields can result in a cross-property validation error. A single flag indicates whether the business object has any validation errors. Different validation errors may have different visualization types, and the business object may have validation errors of different data types, rather than being limited to strings.

### BACKGROUND

Data validation can be performed to help ensure that software receives clean, accurate, and useful input data. Validation rules, business rules, check routines, and/or other mechanisms test input data for compliance with syntactic, semantic, and/or security criteria. During validation, data that do not conform to the criteria are identified, and measures are taken to correct and/or exclude noncompliant data. Various kinds of data validation may be performed, such as format checks, data type checks, range checks, checksum tests, tests for missing values, checks for consistency between different inputs, and other tests.

Data validation may be performed at various times, such as immediately on entry of each input or only after all inputs for a given form or project have been received. Data validation may also be performed by various components, such as by a preprocessing component which operates with a variety of different business applications, or by procedural code embedded within a particular application program, for example. Responses to invalid data can also vary, from simply refusing to accept the data (and thus preventing further progress in the application to which the data was submitted), to suggesting possible alternative inputs a user can choose, to automatically and transparently correcting invalid input.

### SUMMARY

To provide data validation in a timely manner, a server-client application developer may have previously found it necessary to write validation code that operates only within a particular user interface implementation. For example, the developer may write custom business objects that are tightly coupled with the user interface implementation, thereby sacrificing reusability of the validation code.

Some embodiments discussed herein provide an asynchronous reusable validation mechanism. An application's user interface has data fields, and an application object has properties bound respectively to at least some of the user interface data fields for storage of data values entered in the data fields. The asynchronous validation mechanism communicates with a remote validator (e.g., on a server) and also communicates with the application object properties. The asynchronous validation mechanism may be integrated into the user interface by a binding engine, for example.

In a given configuration, multiple validation errors can be exposed to the user interface and associated to one of the object properties, and data input to a single field can be flagged with multiple validation errors. Multiple validation errors exposed to the user interface can also be associated to the object as top-level errors rather than being associated with particular properties of the object. Inconsistency between inputs to different data fields can result in a cross-property validation error. A single flag can be used to indicate whether the business object has any validation errors. Additional flexibility is provided, such that two validation errors may have different visualization types, and the business object may have a set of validation errors of different data types, rather than being limited to strings, for example.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor, at least one memory, an application receiving input through a user interface, and other items in an operating environment which may be present on multiple network nodes, and also illustrating configured storage medium embodiments;

FIG. 2 is a block diagram illustrating user-interface-integrated asynchronous data validation mechanisms in an example architecture;

FIG. 3 is a flow chart illustrating steps of some process and configured storage medium embodiments;

FIG. 4 is a block diagram further illustrating user-interface-integrated asynchronous data validation mechanisms; and

FIG. 5 is a data flow diagram illustrating a particular example of asynchronous data validation.

### DETAILED DESCRIPTION

### Overview

In some environments, it is helpful or even required that data input to an application be validated before the data is accepted and processed. Data validation may be helpful or required regardless of whether input is typed, read over a communication link, read from a file, or received from another program.

Data validation may happen at various levels. A single field at a time may be validated, or validation may check an entire data object and interdependencies of the object's data fields, for example. Sometimes a data field which receives a value at a client (workstation, smart phone, etc.) can only be validated at a server. For example, validation of a user name may include checking whether the user's proffered Social Security Number or telephone number has been previously associated with a different user. Data may be validated in a user interface, e.g., for syntactic requirements or presence, and may also be subject to validation in a thread on the server or elsewhere outside the user interface.

In some situations, application developers want to display any validation error(s) to a user in a manner that provides a continuous and integrated user experience. Furthermore, if input results in multiple errors, developers may want to provide a seamless experience that displays all the errors simultaneously in the user interface (UI). Also, if the errors have different severities, an application may helpfully indicate such differences in the UI. Unfortunately, an application author may feel compelled to write a validation code that is tightly embedded in a particular UI implementation, thereby sacrificing reusability of business objects that are tightly coupled with the specific user interface for validation.

Some embodiments described herein support development and use of custom business objects that are tightly coupled with a user interface solution without severely limiting reuse of validation code. A business object keeps references to user interface components and updates them when a validation error happens, asynchronously and/or on a server.

In a particular embodiment, a validation interface INotifyDataErrorInfo is provided in Microsoft® Silverlight® version 4 software (marks of Microsoft Corporation). This interface provides application program interfaces (APIs) to support server-side and asynchronous validation updates, provides control over how validation errors are visualized (allowing different visualizations for different errors), and provides a way to associate multiple errors to a property or an entire business object. Additionally, the Silverlight® user interface stack supports business objects that implement INotifyDataErrorInfo such that application authors need not write additional code to integrate validation errors in the user interface.

More generally, embodiments may provide APIs for different visualizations for validation errors based on the severity. Such APIs may be internally accessible only and/or they may be public, in a given embodiment. Embodiments may provide APIs that support asynchronous and server-side validations and their notifications to a UI layer. APIs may allow the UI to display multiple errors for a single field. Some embodiments support cross-property validation errors, such that when a data property A results in a validation error on a data property B the platform seamlessly displays errors associated with property B without substantial developer effort to provide the display. Seamless integration of the foregoing capabilities in the UI stack of some embodiments provides user-interface-integrated data validation without requiring application authors to write any additional code in the UI layer.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry. In particular, although it may occur that many embodiments run on workstation or laptop computers, other embodiments may run on mobile devices and/or other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Code” means processor instructions, data (which includes constants, variables, and data structures), or both instructions and data.

“Automatically” means by use of automation (e.g., general purpose computing hardware configured by software for specific operations discussed herein), as opposed to without automation. In particular, steps performed “automatically” are not performed by hand on paper or in a person's mind; they are performed with a machine.

Throughout this document, use of the optional plural “(s)” means that one or more of the indicated feature is present. For example, “object(s)” means “one or more objects” or equivalently “at least one object”.

Whenever reference is made to data or instructions, it is understood that these items configure a computer-readable memory thereby transforming it to a particular article, as opposed to simply existing on paper, in a person's mind, or as a transitory signal on a wire, for example.

Operating Environments

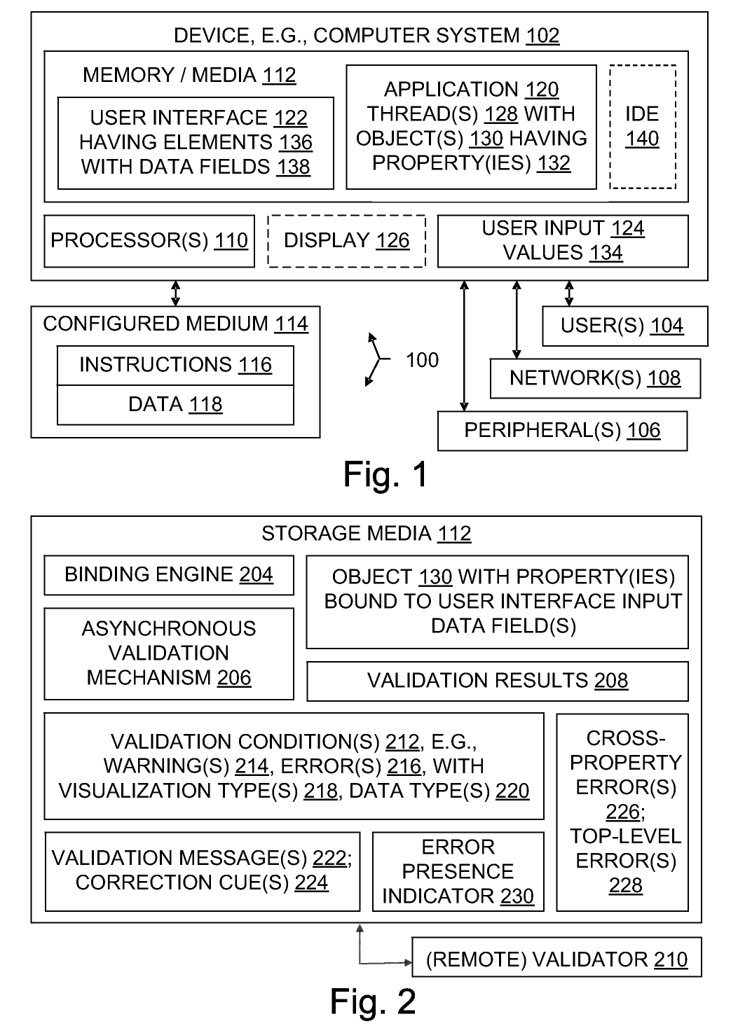

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked.

Human users 104 may interact with the computer system 102 by using displays, keyboards, and other peripherals 106. System administrators, developers, engineers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example.

The computer system 102 includes at least one logical processor 110. The computer system 102, like other suitable systems, also includes one or more computer-readable non-transitory storage media 112. Media 112 may be of different physical types. The media 112 may be volatile memory, non-volatile memory, fixed in place media, removable media, magnetic media, optical media, and/or of other types of non-transitory media (as opposed to transitory media such as a wire that merely propagates a signal). In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a computer-readable storage medium 112. Some other examples of computer-readable storage media 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the medium 114 in which they reside; when that memory is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by as discussed herein, e.g., by binding, validation, interdependency, deployment, execution, modification, display, creation, loading, and/or other operations.

An application 120 with a corresponding user interface 122, other software, user input 124, and other items shown in the Figures may reside partially or entirely within one or more media 112, thereby configuring those media. An operating environment may also include a screen, monitor, or other display 126, as well as other hardware such as buses, power supplies, and accelerators, for instance.

The application 120 may be any type of data processing software, including a program or a collection of programs, for instance, which runs in one or more threads 128 on one or more processors 110 (an environment may be a uniprocessor and/or a multiprocessor environment). Within the application 120, objects 130 having properties 132 (e.g., methods, attributes) help provide logic for processing user input 124, based on particular accepted input values 134.

The user interface 122 has elements 136 (windows, sliders and other controls, etc.). In particular, the user interface elements include data field(s) 138 which receive data, namely, user input 124, from user(s) 104.

A given operating environment 100 may include an Integrated Development Environment (IDE) 140 which provides a developer with a set of coordinated software development tools. In particular, some of the suitable operating environments for some embodiments include or help create a Microsoft® Visual Studio® development environment (marks of Microsoft Corporation) configured to support program development. Some suitable operating environments include Java® environments (mark of Sun Microsystems, Inc.), and some include environments which utilize languages such as C++ or C# (“C-Sharp”), but teachings herein are applicable with a wide variety of programming languages, programming models, and programs, as well as with endeavors outside the field of software development per se that use data validation.

Some items are shown in outline form in FIG. 1 to emphasize that they are not necessarily part of the illustrated operating environment, but may interoperate with items in the operating environment as discussed herein. It does not follow that items not in outline form are necessarily required, in any Figure or any embodiment.

Systems

FIG. 2 illustrates an architecture which is suitable for use with some embodiments. An object 130 within an application 120 is bound to user interface data fields 138 by a binding engine 204. Input to the properties through the data fields is submitted with an asynchronous validation mechanism 206 to obtain data validation results 208. The asynchronous validation mechanism 206 communicates data values to a validator 210, which may reside locally on a non-UI thread or reside remotely on a server computer, for example. Such input could also be sent synchronously.

Data validation results 208 may include validation conditions 212 such as warnings 214 and errors 216. Each validation condition 212 has a visualization type 218 and a data type 220. Visualization types may provide validation messages 222, and in particular may provide correction cues 224. Validation result data types 220 are not necessarily limited to strings.

A given data validation condition 212 may be associated with a single object property 132, with multiple properties, or with the object 130 overall. Cross-property errors 226 (also referred to as cross-field errors) are associated with multiple properties 132. Top-level errors 228 (also referred to as entity-level errors) are associated with the object 130 overall rather than with particular property(ies) of the object. A given object's error presence indicator 230 is a single flag (e.g., a Boolean value) indicating whether any error conditions 212 exist for the object and/or for the object's property(ies).

With reference to FIGS. 1 and 2, some embodiments provide a computer system 102 with a logical processor 110 and a memory medium 112 configured by circuitry, firmware, and/or software to support data validation as described herein.

For example, one system includes a processor 110 in operable communication with a memory. A user interface 122 having data fields 138 resides in the memory. An application object 130 (e.g., an entity object in an application program) in the memory has properties 132 which are bound respectively to user interface data fields 138, that is, the properties will store data values 134 entered in the data fields. An asynchronous validation mechanism 206 is in operable communication with a remote validator 210 and with the application object properties 132, so data values can flow from the data fields to the properties to the validator for validation.

In some embodiments, the system includes a set of multiple validation errors 216 or other conditions 212 exposed to the user interface 122 and associated to one of the object properties 132. That is, an object 130 can expose more than one error per property.

In some embodiments, the system includes a set of multiple validation errors 216 or other conditions 212 exposed to the user interface 122 and associated to the object as top-level errors 228. Top-level errors are associated with the object overall rather than being associated with particular properties of the object. An object can expose more than one top-level error.

In some embodiments, the system includes a cross-property validation error 226, which reflects an inconsistency between the values provided for two or more properties of the object 130. More generally, cross-property validation conditions can be exposed in the user interface as top-level errors, as errors associated with a single property, or as errors associated with several properties that have mutually inconsistent values, for example.

In some embodiments, the system includes two or more validation errors 216 or other conditions 212 having different visualization types 218. Different visualizations can be used for different errors, such as providing a text message for one error and providing a flashing icon or other graphic for another error. More generally, visualizations can differ in more than merely the text of their respective error/warning messages.

In some embodiments, the system includes a set of validation errors 216 or other conditions 212 of different data types 220. In particular, an error's representation is not limited to strings. The objects returned as validation results 208 can be of any data type, and may even include a heterogeneous set of objects, that is, objects of different data types.

In some embodiments, the system includes the asynchronous validation mechanism 206 integrated into the user interface 122 by a binding engine 204. The binding engine provides a seamless integration in that application developers need not develop code to expressly transfer data values from properties to a validator 210 or code to expressly obtain validation results 208 from the validator. Instead, developers can rely on the automatic transfers performed with the binding engine 204.

In some embodiments peripherals 106 such as human user I/O devices (screen, keyboard, mouse, tablet, microphone, speaker, motion sensor, etc.) will be present in operable communication with one or more processors 110 and memory. However, an embodiment may also be deeply embedded in a system, such that no human user 104 interacts directly with the embodiment. Software processes may be users 104.

In some embodiments, the system includes multiple computers connected by a network. Networking interface equipment can provide access to networks 108, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

Processes

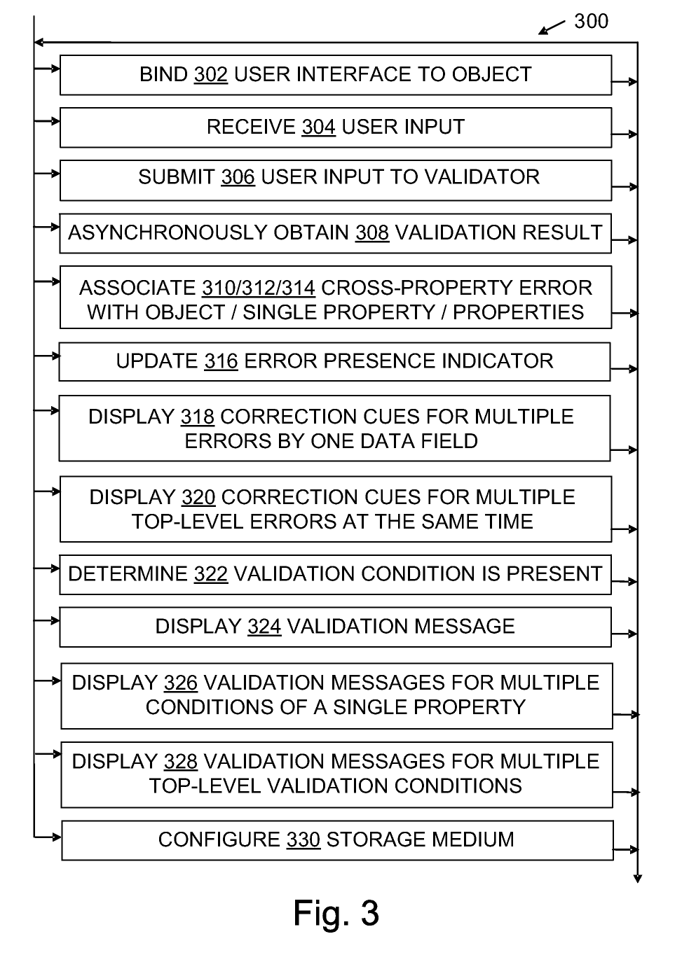

FIG. 3 illustrates some process embodiments in a flowchart 300. Processes shown in the Figures may be performed in some embodiments automatically, e.g., by an application 120, user interface 122, binding engine 204, asynchronous validation mechanism 206 and validator 210 running under control of internal logic and a script or other automated input mechanism requiring little or no manual human user input to run. Processes may also be performed in part automatically and in part manually unless otherwise indicated. In a given embodiment zero or more illustrated steps of a process may be repeated, perhaps with different parameters or data to operate on. Steps in an embodiment may also be done in a different order than the top-to-bottom order that is laid out in FIG. 3. Steps may be performed serially, in a partially overlapping manner, or fully in parallel. The order in which flowchart 300 is traversed to indicate the steps performed during a process may vary from one performance of the process to another performance of the process. The flowchart traversal order may also vary from one process embodiment to another process embodiment. Steps may also be omitted, combined, renamed, regrouped, or otherwise depart from the illustrated flow, provided that the process performed is operable and conforms to at least one claim.

Examples are provided herein to help illustrate aspects of the technology, but the examples given within this document do not describe all possible embodiments. Embodiments are not limited to the specific APIs, implementations, arrangements, displays, features, approaches, or scenarios provided herein. A given embodiment may include additional or different features, mechanisms, and/or data structures, for instance, and may otherwise depart from the examples provided herein.

During a binding step 302, an embodiment binds a user interface 122 (or portion thereof) to one or more object(s) 130. Step 302 may be accomplished using a binding engine 204 or other mechanism, for example.

During an input receiving step 304, an embodiment receives user input 124 at a user interface 122 data field 138. Data field input 124 may be text, audio, still or moving visual, and/or other digital input. Step 304 may be accomplished using familiar user interface mechanisms, for example.

During an input submitting step 306, user input is submitted by an embodiment to a validator 210. Step 306 may include transmitting input values to a non-UI thread, and/or transmitting input values across a network 108 to a remote validator 210, for example. User input values may also be validated on the same UI thread that receives them from the user.

During a validation result obtaining step 308, an embodiment asynchronously obtains a validation result 208. Step 308 is asynchronous with respect to step 306, so that an application 120 can continue processing valid input data while awaiting validation results for other input.

During an associating step 310, a cross-property error 226 or other cross-property condition 212 is associated by an embodiment with an object 130 overall as a top-level condition.

During an associating step 312, a cross-property error 226 or other cross-property condition 212 is associated by an embodiment with a single property 132 of an object 130.

During an associating step 314, a cross-property error 226 or other cross-property condition 212 is associated by an embodiment with multiple properties 132 of an object 130.

Steps 310, 312, 314 may be accomplished by the binding engine 204 and/or by the asynchronous validation mechanism 206.

During a validation indicator updating step 316, an embodiment updates an error presence indicator 230 (e.g., to True or to False) of an object 130 to reflect the presence/absence of one or more validation conditions 212 associated with the object 130 and/or the object's property(ies) 132.

During a single property cues displaying step 318, an embodiment displays multiple correction cues 224 for multiple validation errors associated with a single data field 138. A single property 132 may have multiple validation errors, with corresponding correction cues displayed in or near the property's data field.

During a single object cues displaying step 320, an embodiment displays multiple correction cues 224 for multiple validation errors associated with a single object 130 as top-level conditions. A single object 130 may have multiple top-level validation errors, with corresponding correction cues displayed in or near the object's data field(s).

During an error presence determining step 322, an embodiment determines whether one or more validation conditions 212 have been associated with an object 13 and/or the object's property(ies) 132 through data validation and have not yet been fixed or waived. For example, at the validation mechanism level an embodiment may check for top-level and property-level conditions to perform step 322. At the application level, an embodiment may check the error presence indicator 230 to perform step 322.

During a message displaying step 324, an embodiment displays one or more validation messages 222 for data field(s) of an object, based on validation condition(s) presently associated with the object and/or the object's property(ies) 132.

In a particular example of step 324, during a single property messages displaying step 326, an embodiment displays multiple validation messages 222 based on multiple validation conditions presently associated with a single property 132 of an object 130.

In another particular example of step 324, during a single object messages displaying step 328, an embodiment displays multiple validation messages 222 based on multiple validation conditions presently associated with a single object 130 as top-level conditions.

During a medium configuring step 330, a memory medium 112 is configured by an asynchronous validation mechanism 206, by validation results 208 bound to object properties, or otherwise in connection with a collaborative project extension as discussed herein.

The foregoing steps and their interrelationships are discussed in greater detail below, in connection with various embodiments.

Some embodiments provide a process for asynchronous validation of user input. The process includes binding 302 user interface elements 136 to an object residing in a memory, receiving 304 input 124 to at least one of the bound user interface elements, submitting 306 the input to a validator 210, and asynchronously obtaining 308 a validation result 208 from the validator.

In some cases, the user interface elements 136 are owned by thread(s) 128 executing on a first computer, and the validator 210 resides in a remote second computer which is networked with the first computer. In some cases, the validator 210 resides in the first computer in different thread(s) 128 than the thread(s) that own the user interface elements (that is, the validator resides in one or more non-UI threads).

In some embodiments, the validation result 208 includes a cross-property validation error 226, and the process does at least one of the following steps: associates 310 the cross-property validation error with the object as a whole, associates 312 the cross-property validation error with a single property of the object, associates 314 the cross-property validation error with at least two properties of the object whose values are currently mutually inconsistent.

In some embodiments, the process operates such that the validation result 208 includes at least one of the following: a set of multiple validation errors 216 identified with a single property 132 of the object 130; a set of multiple validation errors 216 identified with the object 130 overall; a set of validation errors 216 of different data types 220; at least two validation errors 216 having different respective visualization types 218.

In some embodiments, the process updates 316 an error presence indicator 230 which indicates to an application program whether any validation errors are present in the validation result.

In some embodiments, the validation result 208 includes at least one validation error 216, and the process displays 318 correction cues for several validation errors next to a single user interface element data field. In some, the process displays 320 correction cues for several top-level errors simultaneously (a top-level error is an error which is associated with the object overall rather than being associated with a particular property of the object).

Some embodiments provide a process for asynchronous validation of user input in an environment which includes user interface elements bound to an object. The process includes submitting 306, to a remote validator 210, user input 124 from at least one of the bound user interface elements. The process asynchronously obtains 308 a validation result 208 from the remote validator, and after determining 322 from the validation result that at least one validation condition is present, the process displays 324 in the user interface 122 at least one validation message 222 identifying the validation condition(s).

In some embodiments, the validation result 208 includes at least one validation result object 130 having a non-string property 132. In some, the validation result 208 includes at least two validation result objects of different data types 220 from each other. In some, the validation result 208 includes a set of multiple validation errors 216 identified with a single property of the business object 130, and in some the validation result 208 includes a set of multiple validation errors 216 which are identified with the business object overall. In some embodiments, the process displays 326 in the user interface validation messages 222 for several validation conditions 212 pertaining to a single property 132 of a business object 130, and in some the process displays 328 in the user interface validation messages 222 for several top-level validation conditions 212 simultaneously, a top-level validation condition being a validation condition pertaining to the business object 130 overall rather than any particular property(ies) of that object.

In some embodiments, the process updates 316 an error presence indicator 230 which indicates that validation errors 216 are present, and the error presence indicator does not distinguish between top-level validation errors and property-level validation errors.

Configured Media

Some embodiments include a configured computer-readable storage medium 112. Medium 112 may include disks (magnetic, optical, or otherwise), RAM, EEPROMS or other ROMs, and/or other configurable memory, including in particular non-transitory computer-readable media (as opposed to wires and other propagated signal media). The storage medium which is configured may be in particular a removable storage medium 114 such as a CD, DVD, or flash memory. A general-purpose memory, which may be removable or not, and may be volatile or not, can be configured into an embodiment using items such as validation results 208 and an asynchronous validation mechanism 206, in the form of data 118 and instructions 116, read from a removable medium 114 and/or another source such as a network connection, to form a configured medium. The configured medium 112 is capable of causing a computer system to perform process steps for user-interface-integrated asynchronous data validation as disclosed herein. FIGS. 1 through 3 thus help illustrate configured storage media embodiments and process embodiments, as well as system embodiments. In particular, any of the process steps illustrated in FIG. 3, or otherwise taught herein, may be used to help configure a storage medium to form a configured medium embodiment.

### Additional Examples

Additional details and design considerations are provided below. As with the other examples herein, the features described may be used individually and/or in combination, or not at all, in a given embodiment.

Those of skill will understand that implementation details may pertain to specific code, such as specific APIs and specific sample programs, and thus need not appear in every embodiment. Those of skill will also understand that program identifiers and some other terminology used in discussing details are implementation-specific and thus need not pertain to every embodiment. Nonetheless, although they are not necessarily required to be present here, these details are provided because they may help some readers by providing context and/or may illustrate a few of the many possible implementations of the technology discussed herein.

Some embodiments include a synchronous and/or asynchronous validation mechanism 206 interface. Some embodiments include an interface called INotifyDataErrorInfo (INDEI), and a binding engine 204 which provides data binding support to natively support the INDEI interface to help provide a richer development and user experience. A version of the INotifyDataErrorInfo interface provides API characteristics discussed below.

A GetErrors(string propertyName) API method returns a list of validation errors 216 associated with the input property 132 name. If the propertyName is null or empty, it returns the list of errors associated with the entire business object 130. The errors returned are Microsoft® Common Language Runtime objects and hence can be used to provide rich visualizations of various types 218.

An Event ErrorsChanged API event is raised when the errors 216 associated with a property 132 or with the entire business object 130 change. This event allows the UI layer to query the business object for a new set of errors to be integrated in the UI 122.

A HasErrors API variable or method provides info as to whether the business object 130 is currently invalid.

With regard to data binding support for INDEI, a Microsoft® Silverlight® data binding engine 204 natively understands an INDEI interface. As such, UI elements 136 which are data bound to business objects 130 that implement INDEI automatically get rich validation error 216 notifications when a new validation error happens. Unlike alternatives, some embodiments support a list or other set of errors 216 per property, rich visualization types 218, and asynchronous validation error notifications.

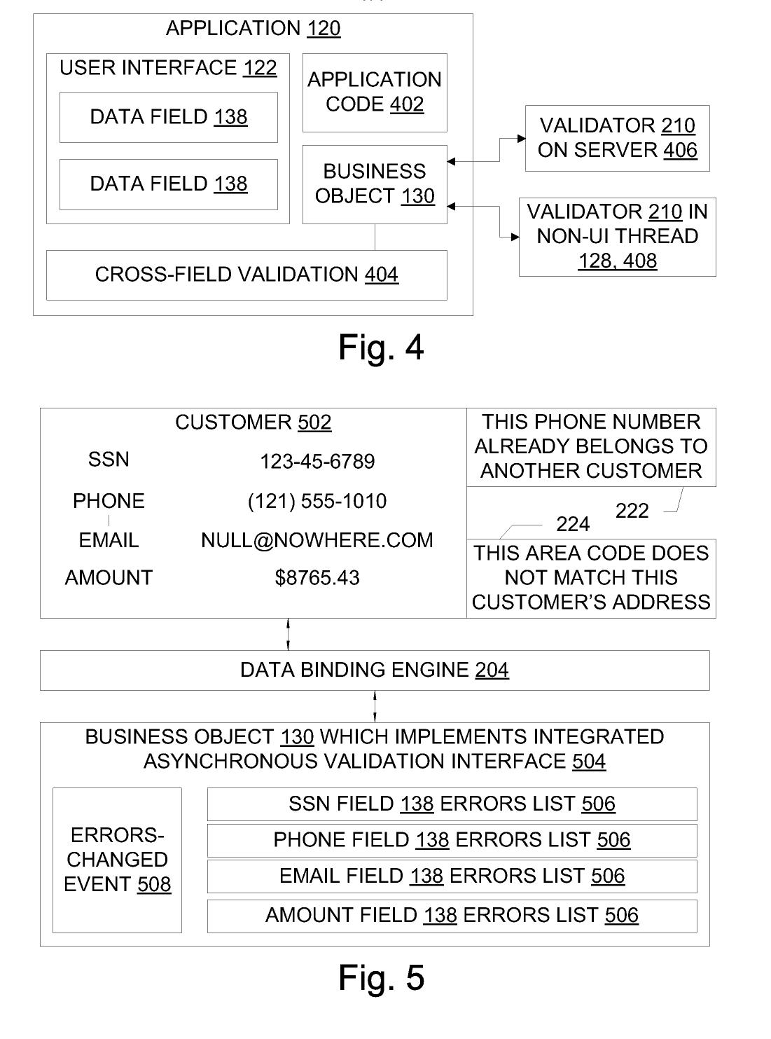

FIG. 4 illustrates a high level view of how validations may be happening at different places in some embodiments. An application 120 includes application code 402 which operates on validated user input to provide desired data processing functionality to users. The application code 402 utilizes business objects 130 which are data bound to a user interface 122. Received user input 124 may be subject, e.g., to cross-field validation 404 by a call made within a business object to check for cross-property errors 226. Received user input 124 may also be subject to validation by a network call made to a remote validator 210 on a server 406, and/or by a call made to a validator 210 in a local or remote non-UI thread 408, for example, or a local UI thread.

With a particular customer form, FIG. 5 illustrates interaction between a business object 130, a binding engine 204, and a user interface 122 in some embodiments. Through a user interface, a customer 502 form is displayed, with data fields 138 for the customer's Social Security Number, phone number, email address, transaction amount, and so forth. Of course, different forms may utilize different data fields than those shown in this example. Mock data is shown in the illustration; respect for actual personal data such as Social Security Numbers and phone numbers is an important design consideration.

The data has been bound to properties 132 of a business object 130 which implements an asynchronous validation mechanism 206 in the form of an asynchronous validation interface 504 integrated by a data binding engine 204 with the user interface that provides the customer form. The asynchronous validation mechanism 206 has submitted the input data to a validator 210, and validation errors 216 have been detected in the data. Validation errors 216 have been placed in lists 506 according to the data field the error(s) pertain to, and an errors-changed event 508 has been raised in the mechanism 206. The data binding engine 204 listens for the event 508, and queries the object 130 for errors pertaining to the properties 132. Corresponding validation message(s) 222 and correction cue(s) 224 are then displayed by the UI to the user, adjacent the erroneous data.

In one implementation, specific details of binding engine 204 operation include the following; it will be understood that these details (and others herein) are implementation specific and hence subject to the prefatory comments above.

An ErrorsChanged(“propertyName”) handler is called by an entity object 130. If an ErrorCollection of validation errors 216 already exists in association with propertyName, then for each error in that collection, remove the error from a set Validation.Errors, raise BindingValidationError(remove) if flag is set, and if the ErrorCollection implements INotifyCollectionChanged then unregister for a CollectionChanged event 508. If an ErrorCollection of validation errors 216 does not already exist in association with propertyName, then the foregoing steps are skipped. Regardless, if getErrors(propertyName) is not empty, then add each error 216 to Validation.Errors, raise BindingValidationError(add) if flag is set, and if the ErrorCollection implements INotifyCollectionChanged then register for a CollectionChanged event 508. Finally, transition control's Error Visual States as per familiar Microsoft® Silverlight® version 3 behavior.

In some embodiments, an asynchronous validation mechanism 206 includes an INotifyDataErrorInfo interface 504. Detailed information will now be provided about the INotifyDataErrorInfo interface, with the understanding that INotifyDataErrorInfo details pertain to specific code and thus need not appear in every embodiment. Likewise, program identifiers and some terminology used in discussing INotifyDataErrorInfo details below are implementation-specific and thus need not pertain to every embodiment, although they may help particular readers understand aspects of some embodiments.

INotifyDataErrorInfo Introduction

Data validation is an important aspect of many business applications, which helps ensure that data stored in a server or other backend location is valid and which may also guide users in their data input tasks. Several mechanisms already exist in client technologies to communicate to an application user when a particular piece of data is invalid and needs to be fixed. In some cases, data validation works closely with data binding, providing an ability to automatically push data between the user interface (UI) and the backend. Typically data is then validated as it is initially read to be displayed in a form, and reciprocally as new user input is flushed into the backend.

Existing Microsoft® Windows Forms (WF) and Microsoft® Windows Presentation Foundation (WPF) client technologies support a familiar IDataErrorInfo interface which allows backend objects to communicate their error information to a UI layer. A Microsoft® Silverlight® version 4 Beta binding engine takes advantage of sources that implement IDataErrorInfo, like the WPF binding engine does. Therefore business objects 130 that were created for WF or WPF can be reused in Silverlight® applications without losing the benefits of their IDataErrorInfo implementation.

However IDataErrorInfo was originally designed for pure client environments such as WF and WPF and shows a limitation in a client-server technology like Silverlight® technology, in that IDataErrorInfo lacks a certain mechanism for notifying consumers that an error status has changed. This lack does not inhibit pure client applications where the error status is known as soon as new data is pushed into the business object 130, since the validation rules are applied locally. But for Silverlight® applications where user-provided data often needs to be validated on a server 406, some embodiments discussed herein provide a mechanism for the binding source to advertise new errors asynchronously, namely, the INotifyDataErrorInfo interface.

Silverlight® Support for IDataErrorInfo

As in the Microsoft .NET® Framework version 1.1 and subsequent releases, the IDataErrorInfo interface is defined in the System.ComponentModel namespace, in the System.dll assembly. The interface reference documentation can be found at msdn dot Microsoft dot com slash en-us slash library slash system dot componentmodel dot idataerrorInfo dot aspx (URL syntax modified to comply with USPTO requirements). The Silverlight® binding engine 204 checks if the source of a binding is a property 132 of an object 130 that implements IDataErrorInfo when Binding.ValidatesOnDataErrors is set to True. By default, Binding.ValidatesOnDataErrors is set to False. In a Silverlight® environment there is no concept of BindingGroup as in WPF, so the binding engine does not access the IDataErrorInfo.Error property to report top-level validation errors; it only accesses the IDataErrorInfo.Item indexer for property-level errors.

INotifyDataErrorInfo Definition

In some embodiments, the interface definition is as follows:

namespace System.ComponentModel {

using System;
using System.Collections;
public interface INotifyDataErrorInfo {

// Returns True if the object has at least one

property-level or top-level error.

bool HasErrors { get; }
// Returns the current set of property-level errors

for the provided property name, or

// the current top-level errors if the argument is

null or empty.

IEnumerable GetErrors(string propertyName);
// Raised when the set of errors for a particular

property has changed, or when the

// top-level errors have changed.
event EventHandler<DataErrorsChangedEventArgs>

ErrorsChanged;

}
public sealed class DataErrorsChangedEventArgs :

EventArgs {

// Constructor for the DataErrorsChangedEventArgs

class. The provided argument can

// be null or empty for top-level object errors.
public DataErrorsChangedEventArgs (string

propertyName);

// Returns the name of the property for which the

errors have changed, or null/empty string

// when the notification is for the top-level

errors.

public string PropertyName { get; }

}

}

Notice that this interface, like IDataErrorInfo, is UI-technology agnostic, hence its declaration in the System.ComponentModel namespace.

There are differences between the IDataErrorInfo interface and the INotifyDataErrorInfo interface. One differentiator is the presence of an ErrorsChanged event, which is meant to be raised by the implementing object when the set of errors for a particular property or for the object itself has changed. This mechanism can be used by business objects to expose new errors asynchronously. In some embodiments, this mechanism also provides a way to expose an error on a dependent property that wasn't modified, and to do so synchronously and asynchronously.

In addition, the INotifyDataErrorInfo interface provides several capabilities lacking in the IDataErrorInfo interface. Using INotifyDataErrorInfo, a business object 130 can expose more than one error 216 per property 132, and a business object 130 can expose more than one top-level error 228. Also, a convenient HasErrors property 132, 230 indicates whether the object 130 is currently valid or not. Moreover, error representation is no longer limited to strings. The validation error objects returned by GetErrors can also be of any data type 220. In fact, GetErrors can return a heterogeneous set of validation error objects as a validation result 208. Developers may decide, however, that those objects override the ToString( )method and return a user-friendly text message 222. The ToString( )method is invoked by default by the Silverlight® binding engine 204 to represent the error 216 in the UI. Other consumers of the interface may do the same. An embodiment can avoid overriding the ToString( ) method by customizing the way the error objects are consumed by the user interface 122, as discussed further herein.

In terms of a user's experience, a user interface 122 layer in an embodiment can display 326 cues 224 for several validation errors 216 next to a single input field 138, can display 328 cues 224 for several top-level errors 228 simultaneously, and can display 324 a general validity cue 224 for the object 130 based on the HasErrors property 132, 230. Moreover, the user interface 122 can consume application-specific error objects as validation results 208, to convey richer information than just a message string. For example, a custom error object can convey whether the validation failure is critical or a mere warning.

Among the developers using this INotifyDataErrorInfo interface, one may expect to find developers who build business objects 130 that implement the interface, application 120 developers who consume the interface (e.g., the HasErrors property in particular), and framework or third party component developers who consume the interface, for example.

The discussion now dives deeper into each INotifyDataErrorInfo member, starting with the GetErrors method:

IEnumerable GetErrors(string propertyName)

When propertyName is a valid property 132 name, the GetErrors method returns an enumerable set of objects that represent the current validation errors 216 associated with this property. When propertyName is null or empty, the GetErrors method returns an enumerable set of objects that represent top-level errors 228 or cross-property validation errors 226. In both cases, the returned value can be null or an empty IEnumerable set to signify that there is no more known error for the provided argument. When the provided propertyName does not point to an existing public property 132, the business object 130 may throw an exception or return null. However, a well-written consumer will not provide an erroneous parameter.

Now consider the ErrorsChanged event:

event EventHandler<DataErrorsChangedEventArgs> ErrorsChanged

The business object 130 raises this event with the argument e.PropertyName when a call to GetErrors(e.PropertyName) would result in a different set of errors. DataErrorsChangedEventArgs.PropertyName points to a public property 132 of the business object. Alternatively, it is null or empty when the set of top-level/cross-property errors has changed. The IEnumerable reference returned by GetErrors(e.PropertyName) may be the same before and after the event is raised, or it may be different. Similarly, some error objects found in the set before the event may reappear in the set after the event. In other words, in this implementation the business object 130 is free to reuse the IEnumerable store and its content between successive ErrorsChanged events, and consumers of the interface should be aware that reuse is possible. Well-written business objects make sure that the HasErrors property returns the correct value when it is being accessed within an ErrorsChanged event handler. The GetErrors method will typically be invoked within an ErrorsChanged event handler as well.

Now consider the HasErrors property:

bool HasErrors { get; }

This property is meant to be a quick and easy way to check if there are known validation errors 216 for the implementing business object 130, regardless of whether the errors are property-level or top-level. If none of the possible GetErrors(propertyName) calls returns an error, the HasErrors property should return false. If the business object also implements INotifyPropertyChanged and HasErrors is exposed publicly, then PropertyChanged should be raised each time the HasErrors value changes.

Consumers can Ignore INotifyCollectionChanged

INotifyDataErrorInfo implementers should not assume that the consumers will check if the IEnumerable set returned by GetErrors( . . . ) also implements INotifyCollectionChanged. An embodiment may expose a collection that implements INotifyCollectionChanged, such as an ObservableCollection<T>, but the Silverlight® binding engine may also ignore that notification mechanism. The consumer relies on the ErrorsChanged event being raised whenever a set of errors has changed.

Dealing with Cross-Property Errors

Cross-property validation errors 226 may have messages 222 such as “The Shipment Date cannot be prior to the Order Date”, for example. In some embodiments the business object 130 has three choices for exposing cross-property validation errors 226 to the user. First, one may treat the error 226 as a top-level error. To do this, one may raise ErrorsChanged with e.PropertyName null or empty to report the error. The UI is likely to show the error in a centralized location for top-level errors. Second, one may associate the error 226 to a single property 132, for example ShipmentDate. To do this, raise ErrorsChanged with e.PropertyName set to “ShipmentDate”. The UI is likely to show a cue next to the Shipment Date input control. Third, one may associate the error 226 to all inconsistent properties. To do this, raise ErrorsChanged with e.PropertyName set to “OrderDate” and again with e.PropertyName set to “ShipmentDate”. The UI is likely to show a cue next to both offending input controls, and the user can correct any of the two fields.

How the Silverlight® Binding Engine Consumes the Interface

Similar to the Binding.ValidatesOnDataErrors boolean property for IDataErrorInfo, the Binding class now also exposes a ValidatesOnNotifyDataErrorInfo property, but this boolean property is set to True by default. The True setting means that the binding engine 204 will be at the lookout for sources that implement INotifyDataErrorInfo. When the source of a binding evaluates to a property 132 of an object 130 that implements INotifyDataErrorInfo, the binding engine will report property-level errors for that property. If the source of a binding evaluates to an object 130 that implements INotifyDataErrorInfo, the binding engine will report top-level errors for this object. Those two situations are not mutually exclusive: the source of a binding can be a property of an INotifyDataErrorInfo object, and itself be an INotifyDataErrorInfo object. Following are some examples for illustration.

Suppose an application 120 deals with two business object types, SocialSecurityNumber and Person, both implementing INotifyDataErrorInfo. Also assume the Person class has an SSN property of type SocialSecurityNumber. These are typical bindings that involve the INotifyDataErrorInfo interface.

Binding to a property:

<TextBox Text=“{Binding Source={StaticResource
samplePerson}, Path=FullName}”/>

In this example, the Source of the TextBox's binding is set to a Person defined in resources. Since Binding.ValidatesOnNotifyDataErrorInfo is True by default, the TextBox will show a red border and tooltip when the Person.FullName property is declared invalid by the person.

Binding to an object:

<vc:ValidationErrorViewer DataContext=“{Binding
Source={StaticResource samplePerson}}”>

Here ValidationErrorViewer represents a custom control capable of displaying its attached Validation.Errors collection. Because the DataContext property is bound to a Person business object, the control's associated Validation.Errors collection will be populated with the top-level person errors.

Binding to both a property and an object:

<vc:ValidationErrorViewer DataContext=“{Binding
Source={StaticResource samplePerson}, Path=SSN}”>

The Silverlight® binding engine 204 detects the fact that the DataContext property is bound to a business object of type SocialSecurityNumber which implements INotifyDataErrorInfo, and realizes that the owning type Person also implements that interface. Therefore the ValidationErrorViewer's associated Validation.Errors collection will be populated with the property-level errors for the Person.SSN property and the top-level errors for the SocialSecurityNumber object.

When a binding is initially set up, the binding engine invokes the GetErrors( . . . ) method to reflect any existing errors. Reading GetErrors( ) may also be allowed in situations other than initial binding setup. The engine will then rely on the ErrorsChanged event to reflect any changes that may occur during the lifetime of the binding. As to how that reporting happens, typically the target of the binding is a FrameworkElement, or it has a FrameworkElement mentor when it is a DependencyObject. The Validation.Errors attached property associated to that FrameworkElement gets updated automatically by the binding engine 204 according to the INotifyDataErrorInfo implementation. For each error object exposed by INotifyDataErrorInfo.GetErrors( . . . ), a ValidationError object gets added to the Validation.Errors collection, in the same order. The error object provided by the business object is pushed ‘as is’ into the ValidationError.ErrorContent property. Unlike treatment of exception-based validation errors, the ValidationError.Exception property remains null. If that FrameworkElement happens to be a Control with a “ValidationStates” state group, it will automatically go into the “InvalidUnfocused” or “InvalidFocused” state when its attached Validation.Errors becomes none-empty and return to the “Valid” state when all the errors are fixed.

See msdn dot Microsoft dot com slash en-us slash library slash system dot windows dot visualstatemanager(VS.95) dot aspx for more information about the VisualStateManager (URL syntax modified per USPTO requirements).

Each ValidationError.ErrorContent value from a Validation.Errors collection can be consumed by the UI and shown to the user. For example, a built-in red tooltip that appeared in the Silverlight® solution version 3 release shows the first ValidationError.ErrorContent value (or ValidationError.ErrorContent.ToString( ) if needed), and ignores the subsequent ones.

If the Binding.NotifyOnValidationError flag is set to True as well, the binding engine 204 makes sure that the FrameworkElement mentioned above raises its BindingValidationError event for each error that gets added or removed from the associated Validation.Errors collection.

The handling of the INotifyDataErrorInfo interface by the Silverlight® binding engine 204 is identical for the BindingMode.OneWay and BindingMode.TwoWay modes. However, when Binding.Mode is set to BindingMode.OneTime the binding engine only propagates the initial errors, if any, and does not listen to the ErrorsChanged notifications. The user sees a snapshot of the errors 216 at the time the binding gets set up.

The Silverlight® binding engine expects the ErrorsChanged event to be raised on the main UI thread. In an alternate approach, the ErrorsChanged event may also be raised on non-UI threads. An exception will be raised if the event is raised on a background thread. Also, in some embodiments the Silverlight® binding engine never accesses the INotifyDataErrorInfo.HasErrors property, because it has no need to do so; the HasErrors property is rather meant for application developers or third party component developers.

Exception, IDataErrorInfo, or INotifyDataErrorInfo-Based Data Validation

In some cases, exception-based validation comes with limitations which include: the error reporting has to be synchronous, the scenario “Binding to an object” above can't be achieved since the reference to the object is not likely to change, the reporting is limited to one error per property, and (purist's view) an input error is not an exception.

The IDataErrorInfo approach's limitations were already listed above. In Silverlight® usage, the main reason to adopt it would be to reuse existing business objects that implement this interface. Generally, using the INotifyDataErrorInfo interface is often the most sensible approach in a Silverlight® solution version 4+ application 120, because the limitations above are not encountered.

In some embodiments, the Silverlight® binding engine 204 is capable of handling cases where the business object 130 adopts more than one approach. The ValidatesOnExceptions, ValidatesOnDataErrors and ValidatesOnNotifyDataErrors Binding flags can all be set to true. However, situations where the business object implements both IDataErrorInfo and INotifyDataErrorInfo are not likely to occur in practice. The exception-based and IDataErrorInfo-based validations influence each other, because together they can only result in one ValidationError in Validation.Errors. Exceptions take precedence. INotifyDataErrorInfo-based validation does not influence the two other approaches and vice-versa, in the Silverlight® SL4 Beta release. This design may be altered in other versions of Silverlight® software, because one view holds that when the UI and backend become out of sync, the UI should no longer show the INotifyDataErrorInfo errors. In some configurations, the new interface can be used to sync validations, allowing a user interface to show cross-field validation errors, rich validation errors, and/or multiple validation errors for an individual property or top-level errors synchronously.

Analysis of a Sample Application

A Visual Studio®.NET 2010 Beta 2 sample Solution discussed here and made available online illustrates use of the INotifyDataErrorInfo interface. To use this sample application, one first sets up a machine with Visual Studio® 2010 Beta 2 or Visual Web Developer Express 2010 Beta 2, Silverlight® Tools for Visual Studio® 2010, and an updated Silverlight® Toolkit for Silverlight® 4 (marks of Microsoft Corporation), which have been made available online. The sample application includes two projects, namely, ValidationControls (a set of reusable base classes), and INotifyDataErrorInfoSample (a concrete use of those base classes to showcase a couple of input forms with synchronous and asynchronous data validations).

Validation Controls' Reusable Classes

In this sample, an Entity class represents a base class for business objects 130 that implement INotifyDataErrorInfo. It stores the known validation errors in its_errors field. The constructor accepts two pieces of data: a flag that turns on entity-level validation when any property changes (only that mode has been tested), and a type that points to a static class responsible for applying all the validation rules for a particular entity type. The public static class, called an entity validation manager, exposes these three methods:

public static void ValidateEntity(Entity entity)
public static void ValidateProperty(Entity entity,

String propertyName, Object validatedValue)

public static void CancelValidation (Entity entity,

String propertyName)

Each application can implement its own way of running its mix of synchronous and asynchronous rules. All application entity validation managers report their findings to entities via the IValidatedEntity interface, implemented by the base Entity class.

public interface IValidatedEntity
{

void AddError(String propertyName, DataErrorInfo

dataErrorInfo);

void NotifyAsynchronousValidationStarted( );
void NotifyAsynchronousValidationCompleted( );

}

Thanks to that interface, an entity validation manager can push a new error 216 into an entity and notify an entity that an asynchronous validation has started or stopped.

At any given time, an entity can be valid, invalid or being validated. This is important information for the application because it typically influences the flow of the user tasks. Thus the entity exposes a public ValidityStatus property of type EntityValidityStatus.

public enum EntityValidityStatus
{

Valid,
Invalid,
Validating

}

The Entity class also handles the validation of properties of type Entity thanks to its ValidateNestedEntity method. This makes it easier to create input forms for editable nested entities (for instance a form for editing Customer and Customer.Order). Each Entity subclass is responsible for clearing existing known errors at the right time. It can call its protected ClearErrors method to do that job. Typically, an entity will do this when a property value is about to change.

DataErrorInfo Class

Instead of using a plain string for its error reporting, the Entity class and its entity validation manager use a more sophisticated DataErrorInfo type 220. This richer type allows applications to handle both regular errors 216 and warnings 214, thanks to the DataErrorInfo.Level property. An application 120 can represent and visualize warnings differently than errors, and can also operate such that warnings do not prevent saving an entity like errors would.

The DataErrorInfo class also helps associate a single cross-field validation failure (e.g., cross-property error 226) with multiple fields 138 on the input form. The DataErrorInfo.ExtendedScope is used for that purpose. The error message 222 is stored in the Data ErrorInfo.Message property. The DataErrorInfo class overrides the ToString( )method; Silverlight's default error tooltip invokes this method when the nature of the error object is not a simple string.

EntityInputWindow Class

The EntityInputWindow class is designed to make it easy to create input forms based on a ChildWindow. The EntityInputWindow's constructor is fed a top-level entity and a flag that indicates whether warnings must be treated like errors or not. This base class takes care of enabling/disabling the OK button according to the validity status of its top-level entity and potential nested entities. Both frontend and backend errors (conditions 212) count. This base class also handles momentarily disabling input controls while the final validation occurs, showing a visual cue when an asynchronous validation is in progress, and triggering the validation of the top-level entity when a nested entity property changed.

ValidationErrorViewer Control

The ValidationErrorViewer is a custom ContentControl that can be used to visualize two types of errors (or warnings): entity-level errors, and property-level errors of a nested entity. The control exposes a DataTemplate property called ErrorTemplate. The control can be used to change the look of the error reporting, and also to consume custom error objects such as DataErrorInfo objects.

Using the Classes

The INotifyDataErrorInfoSample application builds upon those base classes. It uses two concrete Entity types: a SocialSecurityNumber and a Person type. The Person type has a SocialSecurityNumber property to showcase nested entities. The startup UI shows a read-only form for a person and allows bringing up two editing forms: a SocialSecurityNumber editing form that uses the default Silverlight® error reporting look, and a Person editing form that uses a customized look for error and warning reporting. Now for a few words about each building piece of the application.

SampleEntity.cs and SampleEntityValidator.cs

The SampleEntity class derives from Entity and allows each custom entity to point to a data validation class via the Validator property of type SampleEntityValidator. The concrete validator classes implement the entity-specific validation rules, for both property- and entity-level validation. In this illustrative implementation, each property-level or entity-level validation process includes a synchronous phase, thanks to the SampleEntityValidator.ValidateSynchronous( . . . ) virtual method, and two asynchronous phases, thanks to the SampleEntityValidator.ValidateAsynchronous1( . . . ) and SampleEntityValidator.ValidateAsynchronous2( . . . ) virtual methods. This is a simplification; many professional applications are not likely to follow such a pattern.

SampleEntityValidationManager.cs and ValidationInfo.cs

The SampleEntityValidationManager is the conductor that invokes those three virtual methods when it is requested to validate a property or entity. It is a concrete entity validation manager (a concept mentioned earlier) and therefore exposes the ValidateEntity, ValidateProperty and CancelValidation static methods. To simulate asynchronous validations, it launches two timers for each validation request. When those timers expire, somewhere between one and two seconds later, the ValidateAsynchronous1( ) and ValidateAsynchronous2( ) virtual methods get invoked. In a more complex usage, a web service call might be involved in validating the piece of data.

The SampleEntityValidationManager keeps track of the timers that were launched and for which purpose, thanks to a dictionary of DispatcherTimer (keys) and Validation Info (values) objects. The use of DispatcherTimer objects guarantees that the validation results will be handed off to the binding engine 204 via the ErrorsChanged event on the UI thread 128. The application-specific Validation Info class allows the entity validation manager to figure out which entity or entity property needs to be validated when a timer expires. The dictionary is also used when the entity validation manager is requested to cancel a validation.

SocialSecurityNumber.cs and Person.cs

The SocialSecurityNumber and Person classes are two concrete implementations of SampleEntity. All the heavy lifting is done in the base SampleEntity and Entity classes—the concrete implementations are minimalist.

SocialSecurityNumberValidator.cs and PersonValidator.cs

The SocialSecurityNumberValidator and PersonValidator classes derive from SampleEntityValidator and define concrete validation rules for their respective entity types. When validators 210 need to report an error or warning, they instantiate a new DataErrorInfo object and hand it off to the offending entity via the IValidatedEntity.AddError( . . . ) method.

MainPage.xaml and MainPage.cs

MainPage.xaml is the startup page of the application 120 which shows a default person in a read-only fashion. An “Edit SSN” button brings up a simple SocialSecurityNumberInputWindow child window, while an “Edit Person” button brings up a more elaborate PersonInputWindow child window. The potential changes made to the social security number or person are saved when the child window is closed with an OK button. Screenshots have been placed online in a whitepaper, and in documentation submitted with this application.

SocialSecurityNumberinputWindow.xaml, SocialSecurityNumberinputWindow.cs

A SocialSecurityNumberInputWindow derives from EntityInputWindow. It does not do any UI customization and treats warnings as regular errors. The DataErrorInfo.ToString( )method is invoked to show red tooltips, and only the first error Validation.Errors[0] shows up. For example, a red tooltip error message may state “Given the SSN Issue Location ‘New York’ the expected range for the SSN area number is 50-134. Note that due to a bug in a Silverlight SDK DatePicker control, an Issue Date field may not show red validation failure cues.

PersonInputWindow.xaml and PersonInputWindow.cs

PersonInputWindow provides another EntityInputWindow concrete implementation. However this time, warnings 214 are treated differently; they show up orange instead of red and they don't disable the OK button. Accordingly, the person data can be saved with existing warnings. The XAML for the TextBox, ComboBox, DatePicker validation tooltips is customized to take advantage of the DataErrorInfo richness. That customization also results in displaying 326 multiple errors/warnings per field 138 instead of the default singleton. For example, the following messages 222 can be simultaneously displayed: “The Issue Date filed cannot specify a date in the future”, “SSN numbers in the [700, 728] areas were only issued before Jul. 1, 1963”, “The person's birth date cannot come after the SSN's issue date”. A custom DataTemplate is also specified for the two Validation ErrorViewer.ErrorTemplate properties in order to match the look of the validation tooltips.

Intentional Mistakes

Using the sample application, here are some basic scenarios one can run through to provoke validation failures. Each example assumes non data has been input (start from scratch each time).

Scenarios for the SSN Form

Type in 222 instead of 111 and tab off; this generates cross-field errors 226.

Type in 700 instead of 111, 1/18/1969 instead of 1/18/1949 and tab off; this generates cross-field errors 226, plus an entity-level error 228.

Type in abc instead of 111 and tab off; this generates a frontend property-level error 216.

Type in 0 instead of 11 and tab off; this generates a backend property-level error 216.

Scenarios for the Person Form

Empty the Full Name field and tab off; this generates a backend property-level error 216.

Type abc instead of 111 and tab off; this generates a frontend property-level error 216.

Type 12/8/1950 instead of 12/8/1948 and tab off; this generates a Person entity-level error 228.

Type 222 instead of 111 and tab off; this generates cross-field warnings 214.

Type 1000 instead of 111 and tab off; this generates multiple property-level errors.

Type 222 instead of 111, select Delaware instead of NewYork; Person raises a property warning 214 for Person.SocialSecurityNumber.

Type 700 instead of 111, 1/18/1969 instead of 1/18/1949, select Other instead of NewYork; this generates an SSN entity-level warning, plus a Person property-level warning.

### CONCLUSION

Although particular embodiments are expressly illustrated and described herein as processes, as configured media, or as systems, it will be appreciated that discussion of one type of embodiment also generally extends to other embodiment types. For instance, the descriptions of processes in connection with FIG. 3 also help describe configured media, and help describe the operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or procedural acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

What is claimed is:

1. A system comprising:
a processor in operable communication with a memory;
a user interface residing in the memory, the user interface having data fields;
an application object having properties bound respectively to at least some of the user interface data fields for storage of data values entered in the data fields;
an asynchronous validation mechanism in operable communication with a remote validator and with the application object properties.

2. The system of claim 1, further comprising a set of multiple validation errors exposed to the user interface and associated to one of the object properties.

3. The system of claim 1, further comprising a set of multiple validation errors exposed to the user interface and associated to the object as top-level errors which are associated with the object overall rather than being associated with particular properties of the object.

4. The system of claim 1, further comprising a cross-property validation condition.

5. The system of claim 1, further comprising two validation conditions having different visualization types.

6. The system of claim 1, further comprising a set of validation errors of different data types.

7. The system of claim 1, wherein the asynchronous validation mechanism is integrated into the user interface by a binding engine.

8. A computer-readable non-transitory storage medium configured with data and with instructions that when executed by at least one processor causes the at least one processor to perform a process for asynchronous validation of user input, the process comprising the steps of:
binding user interface elements to an object residing in a memory;
receiving input to at least one of the bound user interface elements;
submitting the input to a validator; and
asynchronously obtaining a validation result from the validator.

9. The configured medium of claim 8, wherein the user interface elements are owned by thread(s) executing on a first computer, and the validator resides in at least one of the following locations:
in a remote second computer which is networked with the first computer;
in the first computer in different thread(s) than the thread(s) that own the user interface elements.

10. The configured medium of claim 8, wherein the validation result includes a cross-property validation condition, and the process further comprises at least one of the following steps:
associating the cross-property validation condition with the object as a whole;
associating the cross-property validation condition with a single property of the object;
associating the cross-property validation condition with at least two mutually inconsistent properties of the object.

11. The configured medium of claim 8, wherein the validation result includes at least one of the following:
a set of multiple validation errors identified with a single property of the object;
a set of multiple validation errors identified with the object overall;
a set of validation errors of different data types;
at least two validation errors having different respective visualization types.

12. The configured medium of claim 8, wherein the process further comprises updating an error presence indicator which indicates to an application program whether any validation conditions are present in the validation result.

13. The configured medium of claim 8, wherein the validation result includes at least one validation error, and the process further comprises at least one of the following steps:
displaying correction cues for several validation conditions next to a single user interface element data field;
displaying correction cues for several top-level errors simultaneously, a top-level error being an error which is associated with the object overall rather than being associated with a particular property of the object.

14. A process for asynchronous validation of user input in an environment which includes user interface elements bound to an object, comprising the steps of:
submitting, to a remote validator, user input from at least one of the bound user interface elements;
asynchronously obtaining a validation result from the remote validator;
determining from the validation result that at least one validation condition is present; and
displaying in the user interface at least one validation message identifying the validation condition(s).

15. The process of claim 14, wherein the validation result includes at least one object having a non-string property.

16. The process of claim 14, wherein the validation result includes at least two objects of different types from each other.

17. The process of claim 14, wherein the validation result includes a cross-property validation error, and the process further comprises at least one of the following steps:
associating the cross-property validation error with the object as a whole;
associating the cross-property validation error with a single property of the object;
associating the cross-property validation error with at least two mutually inconsistent properties of the object.

18. The process of claim 14, wherein the validation result includes at least one of the following:
a set of multiple validation errors identified with a single property of the object;
a set of multiple validation errors identified with the object overall.

19. The process of claim 14, comprising at least one of the following steps:
displaying in the user interface validation messages for several validation conditions pertaining to a single property of the object;
displaying in the user interface validation messages for several top-level validation conditions simultaneously, a top-level validation condition being a validation condition pertaining to the object overall rather than any particular property(ies) of the object.

20. The process of claim 14, comprising updating an error presence indicator which indicates that validation errors are present without the error presence indicator distinguishing between top-level validation errors and property-level validation errors.
